(19) United States
(12) Patent Application Publication
(10) Pub. No.: US 2022/0184900 A1
(43) Pub. Date: Jun. 16, 2022

(54) Method and Apparatus For Forming a Composite Object

(71) Applicant: Remarkable Foods, Inc., Clark, NJ (US)

(72) Inventor: James Patrick Downs, Lawton, MI (US)

(21) Appl. No.: 17/119,375

(22) Filed: Dec. 11, 2020

(51) Int. Cl. B29C 70/48; B29C 70/54; B29C 70/44

(52) U.S. Cl. CPC B29C 70/48; B29C 70/443; B29C 70/547

(57) ABSTRACT

An apparatus can include a base mold and a silicone bag attached to the base mold. The base mold and the silicone bag can define a primary chamber in fluid communication with a primary vacuum port and a resin channel in fluid communication with the primary chamber. Resin can be injected into the resin channel and, with the assistance of a vacuum pressure applied at the primary vacuum port, resin flows from the resin channel into the primary chamber where it infuses a porous material. The base mold and silicone bag also define an outer vacuum channel that holds the silicone bag in place. The apparatus can be used in a method of manufacturing composite materials.

### TECHNICAL FIELD

Embodiments of the technology relate generally to a method and apparatus that uses a vacuum bag to form a composite object.

### BACKGROUND

Composite materials are useful in forming a variety of structures because they can provide superior strength in relation to their weight. One approach to forming composite materials involves placing a porous material, such as a fiber material, within a base mold, enclosing the porous material within a vacuum, and drawing resin into the porous material. After the resin hardens, the vacuum is removed and the composite object is removed from the mold. The resulting composite object comprises the hardened resin and the reinforcing porous material into which the resin was absorbed.

As one example, U.S. Pat. No. 4,942,013 to Palmer describes a process in which a fiber material is placed within a vacuum bag and resin is drawn into the bag by a vacuum source. However, the process described in Palmer is not efficient and cost-effective as it requires an absorbent material to draw the resin into the vacuum bag, a non-porous sealing film placed on top of the absorbent material, and a breathable cloth layer placed on top of the non-porous sealing film. Finally, when Palmer's vacuum bag is placed on top of the multiple layers, one or more seals is required to secure the perimeter of the vacuum bag. The method described in Palmer can have poor performance due to the absorbent material interfering with the ability of the vacuum source to efficiently and uniformly draw the resin into the fiber material. Additionally, the absorbent material and the layers placed on top of the absorbent material cannot be used many times to create multiple composite objects in a repeatable process because hardened resin accumulates on their surfaces. Accordingly, the process described in Palmer results in significant waste of time and materials when multiple composite objects are manufactured.

As another example, U.S. Pat. No. 5,439,635 to Seeman describes a process for forming composite objects using a vacuum bag. However, the vacuum bag described in Seeman has undesirable complexities in that it requires an elongated flow conduit and a layer that contains resin distribution channels. Additionally, the layer of distribution channels in the vacuum bag can interfere with the ability of the vacuum source to effectively and uniformly draw the resin into the porous material.

As yet another example, U.S. Pat. No. 7,014,809 to Audette describes a process for making a reusable vacuum bag. However, the process described in Audette does not describe effective techniques for securing the vacuum bag to a mold. Additionally, Audette does not address techniques for ensuring efficient and uniform distribution of resin into the porous material within the vacuum bag.

Accordingly, in view of the foregoing shortcomings in the prior art, an improved process for forming a vacuum bag would be beneficial. Additionally, an improved method of using a vacuum bag in the formation of a composite object would be beneficial. The following disclosure addresses one or more of the shortcomings in the prior art and describes additional advantages of the disclosed methods and apparatus.

### SUMMARY

The present disclosure is generally directed to an apparatus and method that uses a vacuum bag to form a reinforced composite object. In one example embodiment, the present disclosure is directed to an apparatus comprising a base mold having a top mold surface and a silicone bag that is secured to the top mold surface. An inner bag surface of the silicone bag and the top mold surface define a series of features including a primary chamber, a resin channel, and an outer vacuum channel. The primary chamber holds a porous material that is infused with resin to form a composite object. The primary chamber is in fluid communication with a primary vacuum port. The resin channel is in fluid communication with the primary chamber and a resin injection port. Lastly, the outer vacuum channel is in fluid communication with an outer vacuum port. An inner touchdown is located between the resin channel and the outer vacuum channel and provides a seal between the inner bag surface and the top mold surface. An outer touchdown is located outside the outer periphery of the outer vacuum channel and provides a seal between the inner bag surface and the top mold surface at the outer perimeter of the silicone bag.

In the foregoing apparatus, a vacuum applied to the outer vacuum channel secures the silicone bag to the base mold at the outer touchdown and the inner touchdown. The arrangement of the outer vacuum channel, the outer touchdown, and the inner touchdown eliminates the need for adhesives or other mechanisms to secure the silicone bag to the base mold when forming a composite object. In an example embodiment, one or more protrusions can extend from the inner bag surface into the outer vacuum channel. The one or more protrusions prevent the outer vacuum channel from completely collapsing when a vacuum is applied to the outer vacuum channel. Therefore, the one or more protrusions assist in maintaining a vacuum in the outer vacuum channel.

In another example embodiment, the present disclosure is directed to a method of manufacturing a composite object. The method comprises the steps of placing a porous material on a top mold surface of a base mold, placing a silicone bag onto the porous material and the top mold surface, and applying a secondary vacuum to an outer vacuum chamber to secure the silicone bag to the top mold surface. Once the silicone bag is secured to the top mold surface by the outer vacuum chamber, resin is injected into a resin channel surrounding a primary chamber containing the porous material. The resin travels from the resin channel into the primary chamber and the resin infuses the porous material. A primary vacuum port attached to the primary chamber provides a vacuum that assists in drawing the resin uniformly into the porous material.

In the foregoing method, the secondary vacuum applied to the outer vacuum channel secures the silicone bag to the base mold at the outer touchdown and the inner touchdown. The arrangement of the outer vacuum channel, the outer touchdown, and the inner touchdown eliminates the need for adhesives or other mechanisms to secure the silicone bag to the base mold when forming a composite object. In an example embodiment, one or more protrusions can extend from the inner bag surface into the outer vacuum channel. The one or more protrusions prevent the outer vacuum channel from completely collapsing when a vacuum is applied to the outer vacuum channel. Therefore, the one or more protrusions assist in maintaining a vacuum in the outer vacuum channel.

Following the foregoing method, the resin is allowed to cure thereby forming the composite object made of the porous material and the cured resin. Once the resin is cured, the silicone bag is removed from the top mold surface and the composite object is removed from the base mold. Thereafter, the base mold and the silicone bag can be used again to repeat the method and form another composite object.

In yet another example embodiment, the present disclosure is directed to a method of forming a silicone bag. The method comprises the steps of placing wax mold material onto a top mold surface of a base mold. The wax mold material simulates the shape of the composite object that is to be ultimately formed. The wax mold also defines the features of the inner bag surface. After the wax mold material is placed on the top mold surface, at least three silicone ports are placed on the wax mold material. The three silicone ports include a primary vacuum silicone port, an outer vacuum silicone port, and a resin injection silicone port. After the silicone ports are positioned, a first layer of silicone is sprayed onto the wax mold material and the three silicone ports. A mesh layer is placed on the first layer of silicone as it dries. Thereafter, at least one secondary layer of silicone is sprayed onto the mesh layer. Once the silicone dries, the silicone bag has been formed. The silicone bag can be removed from the wax mold material on the top mold surface. Once the silicone bag has been formed, the wax mold material can be removed from the base mold and the base mold and the silicone bag can be used to form composite objects.

In the foregoing example method of forming a silicone bag, the wax material placed on the base mold can be shaped to optimize the features on the inner bag surface. As one example, the wax mold material can be shaped so that protrusions are formed along an outer vacuum chamber of the bag to facilitate maintaining a vacuum seal when the bag is in use.

The foregoing embodiments are non-limiting examples and other aspects and embodiments will be described herein.

### BRIEF DESCRIPTION OF THE DRAWINGS

The accompanying drawings illustrate only example embodiments of a method and apparatus for forming a reinforced composite object and therefore are not to be considered limiting of the scope of this disclosure. The principles illustrated in the example embodiments of the drawings can be applied to alternate methods and apparatus for forming a reinforced composite object. Additionally, the elements and features shown in the drawings are not necessarily to scale, emphasis instead being placed upon clearly illustrating the principles of the example embodiments. Certain dimensions or positions may be exaggerated to help visually convey such principles.

FIG. 1 is a top perspective view of a base mold with wax mold material placed thereon in accordance with an example embodiment of the disclosure.

FIG. 2 is a top perspective view of another base mold with wax mold material placed thereon in accordance with an example embodiment of the disclosure.

FIG. 3 illustrates a method for forming a silicone bag in accordance with an example embodiment of the disclosure.

FIG. 4 illustrates a partial cross sectional view of a silicone bag secured to a base mold and arranged to form a composite object in accordance with an example embodiment of the disclosure.

FIG. 5 is a top perspective view of a silicone bag secured to a base mold and arranged to form a composite object in accordance with an example embodiment of the disclosure.

FIG. 6 illustrates a method for forming a composite object in accordance with an example embodiment of the disclosure.

FIG. 7 is a top perspective view of an apparatus for forming a composite object in accordance with an example embodiment of the disclosure.

FIG. 8 is a bottom view of the apparatus of FIG. 7 used for forming a composite object in accordance with an example embodiment of the disclosure.

FIG. 9 is another bottom view of the apparatus of FIG. 7 used for forming a composite object in accordance with an example embodiment of the disclosure.

FIG. 10 is a top perspective view of the composite object after the silicone bag has been removed from the mold in accordance with an example embodiment of the disclosure.

FIG. 11 is a top perspective view of the composite object after it has been removed from the mold and turned over in accordance with an example embodiment of the disclosure.

### DETAILED DESCRIPTION OF EXAMPLE EMBODIMENTS

The example embodiments discussed herein are directed to methods and apparatus for forming composite objects. The example embodiments described herein can be used to form composite objects used in a wide variety of applications including components for vehicles, aircraft, watercraft, buildings, manufacturing equipment, and consumer products. As will be described further in the following examples, the methods and apparatus described herein improve upon prior art approaches to forming composite objects. The techniques described herein provide for an optimized and more durable silicone bag that can be used many times to form composite objects. The techniques described herein eliminate undesirable components and minimize wasted materials when compared to prior art approaches. Additionally, the techniques described herein optimize the speed and uniformity with which a resin infuses a porous material to form the composite object.

In the following paragraphs, particular embodiments will be described in further detail by way of example with reference to the drawings. In the description, well-known components, methods, and/or processing techniques are omitted or briefly described. Furthermore, reference to various feature(s) of the embodiments is not to suggest that all embodiments must include the referenced feature(s).

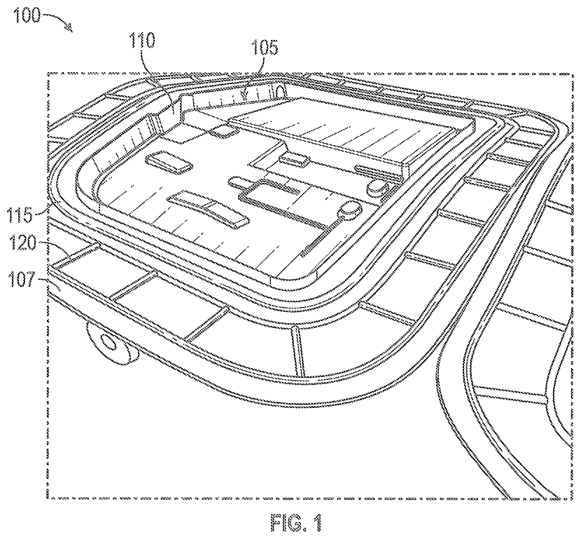

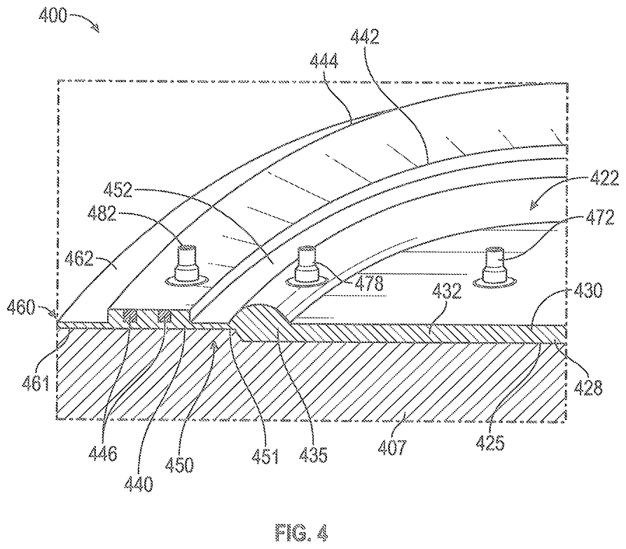

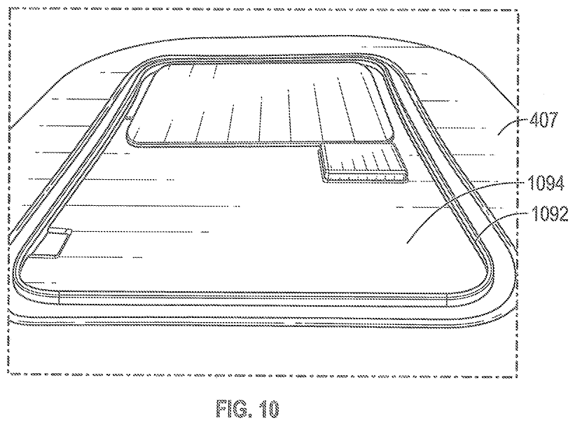

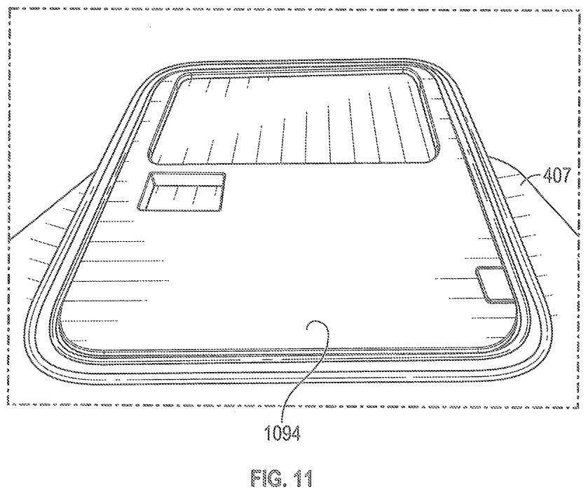

FIGS. 1, 2, and 3, pertain to the apparatus and method for forming a reusable silicone bag. Once the silicone bag is formed, it can be used as illustrated in FIGS. 4-9 to form composite objects. FIGS. 10 and 11 illustrate an example of a composite object formed using the apparatus and methods described herein.

Referring now to FIG. 1, a top perspective view of an apparatus 100 is illustrated in accordance with the example embodiments of the present disclosure. Apparatus 100 includes a base mold 107 that has a top mold surface which defines a cavity 105. The base mold 107 can be made from a high-temperature tooling material such epoxy or vinyl. The cavity 105 is filled with wax mold material 110. The wax mold material 110 is pliable and can be formed to simulate the shape of the composite object that will ultimately be manufactured using the mold and the silicone bag.

The wax mold material also can be placed at other locations on the base mold 107 in order to form features of the silicone bag. Specifically, a semi-cylindrical wax mold material 115 is placed around the perimeter of the cavity 105. The semi-cylindrical wax mold material 115 forms a raised feature extending from the surface of the base mold and will form a resin channel in the silicone bag as described further below. The shape and dimensions of the semi-cylindrical wax mold material 115 can vary to suit the requirements for a particular resin channel and in alternate embodiments the wax mold material can have other cross sectional shapes such as rectangular. As one example, the diameter of the semi-cylindrical wax mold material 115 can range from ⅜ inch to ¾ inch.

Additional wax mold material 120 can be placed near the outer perimeter of the base mold 107. Wax mold material 120 forms another raised feature extending from the surface of the base mold 107 and is configured to form an outer vacuum channel in the silicone bag. Wax mold material 120 can take a variety of shapes and dimensions. In the example illustrated in FIG. 1, the pattern of wax mold material 120 will form a plurality of outer vacuum channels in the silicone bag. In other examples, it is beneficial to form the wax mold material 120 so that it creates a plurality of channels and protrusions in the outer vacuum channel of the silicone bag. Having a plurality of channels and protrusions in the outer vacuum channel of the silicone bag prevents the outer vacuum channel from completely collapsing when a vacuum is applied.

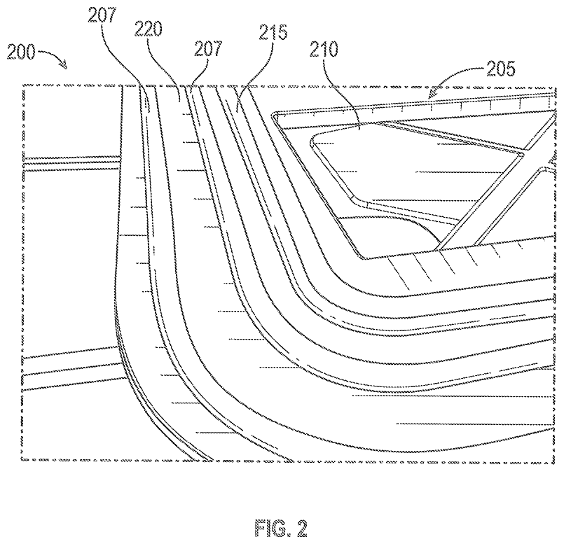

Referring now to FIG. 2, a top perspective view of another example apparatus 200 is illustrated in accordance with example embodiments of the present disclosure. Apparatus 200 is similar to apparatus 100 in that it comprises a base mold on which wax mold material is placed. In this example, the majority of the base mold is covered with wax mold material, but narrow portions of the base mold 207 remain exposed. The base mold 207 includes a cavity 205 into which wax mold material 210 is placed. As in the example of FIG. 1, the wax mold material 210 is formed to simulate the shape of the composite object that will be formed at a later point using the base mold and a reusable silicone bag.

Similar to the apparatus of FIG. 1, a semi-cylindrical wax mold material 215 is placed around the perimeter of the cavity 205. The semi-cylindrical wax mold material 215 forms a raised feature extending from the top surface of the mold base and the semi-cylindrical wax mold material is shaped to form a resin channel in the silicone bag that is to be formed using the apparatus 200. Similar to the example in FIG. 1, the shape and dimensions of the semi-cylindrical wax mold material 115 can vary to suit the requirements for a particular resin channel. As one example, the diameter of the semi-cylindrical wax mold material 115 can range from ⅜ inch to ¾ inch.

Apparatus 200 also includes an outer wax mold material 220 placed near the perimeter of the mold 207. Similar to the apparatus in FIG. 1, the outer wax mold material 220 forms a raised feature extending above the top surface of the base mold so that it will form an outer vacuum channel in the silicone bag. In one example, recesses can be formed in the outer wax mold material 220 so that when the silicone bag is formed, the outer vacuum channel will have protrusions extending into the outer vacuum channel. The protrusions extending into the outer vacuum channel prevent collapse of the outer vacuum channel when a vacuum is applied.

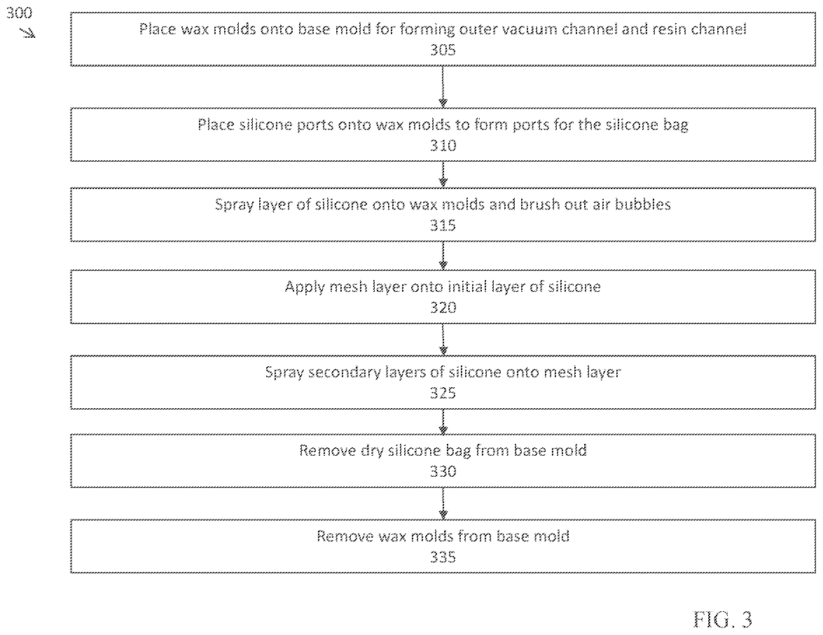

Referring now to FIG. 3, an example method 300 is illustrated which describes a process for forming a reusable silicone bag using the example apparatus shown in FIG. 1 or FIG. 2. Beginning with step 305, wax mold material is placed onto the top surface of the base mold as illustrated in FIGS. 1 and 2. As described previously, the wax mold material is placed in the cavity of the mold to simulate the composite object that is to be made. Additionally, wax mold material is placed along the outer portions of the mold to create features that will form the resin channel and the outer vacuum channel.

In step 310, ports are placed in selected positions on the wax mold material. The ports can be made from silicone or other pliable materials. The ports typically are molded from a more rigid type of silicone than the liquid silicone that is sprayed onto the mold to form the bag. Forming the ports from a more rigid material facilitates securing the vacuum and resin lines that are later attached to the ports. The vacuum lines and a resin line will be described further during the subsequent process for creating the composite object. At least one primary port is placed on the wax mold material located in the central cavity of the mold and this primary port will be used for a vacuum assist line. At least one resin port is placed on the wax mold material that will form the resin channel and this resin port will be used to attach the resin line. At least one outer vacuum port is placed on the outermost wax mold material that forms the outer vacuum channel and this outer vacuum port will be used to connect an outer vacuum line. In alternate embodiments, additional ports may be placed in various positions so that other lines can be connected to the silicone bag.

In step 315, the process for creating the bag begins with the first layer of liquid silicone being sprayed onto the base mold, the wax mold material, and the ports. Various commercially available liquid silicone products can be used, such as Elastosil C 1500 A+B US available from Wacker Silicones. It is recommended that as the liquid silicone is drying, air bubbles should be brushed from the liquid silicone as air pockets remaining in the final silicone bag contribute to weakening of the bag. In step 320, a mesh layer is applied on top of the first layer of silicone. The mesh layer can be made from nylon or comparable materials and the mesh layer contributes to the strength to the silicone bag. Next, in step 325, a secondary layer of liquid silicone is sprayed onto the mesh layer. As in step 315, it is recommended that air bubbles be brushed from the secondary layer of liquid silicone as it is drying. Step 325 can be repeated several times if additional layers of silicone are desired in forming the bag. As one example, each layer of silicone applied is approximately ⅛ inch thick when it dries.

In step 330, once the final layer of liquid silicone has been applied and has dried, the silicone bag can be removed from the base mold. The silicone bag will have features formed by the shapes of the wax mold material placed on the base mold, including a resin channel and an outer vacuum channel. In step 335, the wax mold material is removed from the base mold so that the base mold and the silicone bag can be used for manufacturing composite objects as described further in connection with FIGS. 4-11.

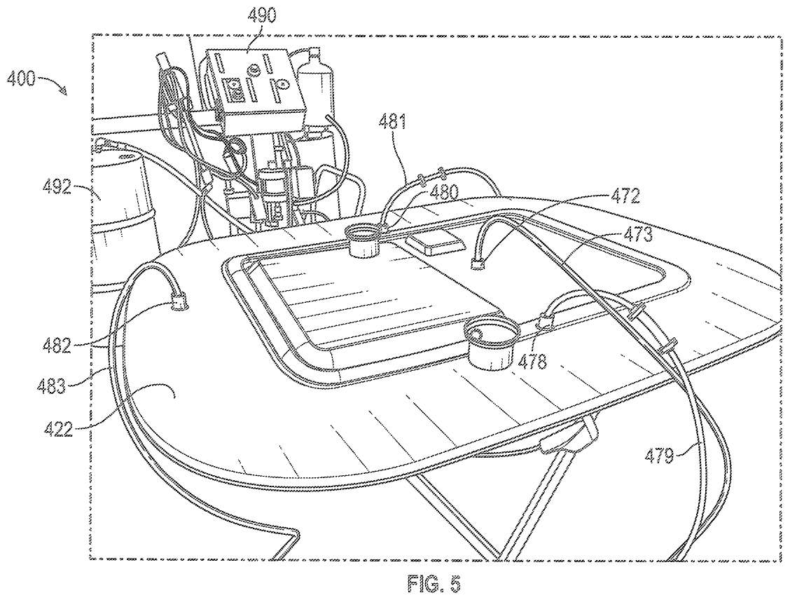

Referring now to FIGS. 4, 5 and 6, an example apparatus 400 and process 600 for manufacturing a composite object will be described. FIG. 5 illustrates a silicone bag 422 placed on a base mold, wherein the silicone bag can be formed according to the process described previously in connection with FIGS. 1-3. FIG. 4 illustrates a schematic partial cross sectional view of the silicone bag 422 placed on a base mold 407. When the silicone bag 422 is placed on the base mold 407, the inner bag surface 428 and the top mold surface 425 define a primary chamber 430. As illustrated in FIG. 4, a porous material 432 is placed in the primary chamber 430. The porous material 432 can be any material that can be infused with resin to form a composite object. Examples of the porous material 432 include fiberglass, carbon fibers, Kevlar, carbon nanotubes, and other structures with pores that can be filled with resin.

The primary chamber is in fluid communication with primary vacuum assist port 472. The primary vacuum assist port 472 is coupled to a vacuum assist line 473 that is attached to a vacuum pump assembly 490 and that provides a vacuum force on the primary chamber 430. The primary vacuum assist port 472 can have a slightly smaller diameter than the outside diameter of the vacuum assist line 473 causing the port to stretch when the line is inserted therein and thereby securing the line in the port. The other ports and lines described herein can be joined in a similar manner. Supplying a vacuum force to the primary chamber 430 assists in drawing resin uniformly into the primary chamber 430 and the porous material 432. A uniform distribution of the resin throughout the porous material 432 is important in producing a durable composite object. As illustrated in FIG. 5, the vacuum assist port 472 can be located at or near the center of the silicone bag 422 and the primary chamber 430 so that the vacuum force is applied uniformly to the porous material 432. In alternate embodiments, such as where the composite object has an unusual shape, multiple vacuum assist ports can be manufactured into the silicone bag 422 where having multiple vacuum assist forces at different positions in the apparatus would be helpful in forming the composite object.

The inner bag surface 428 and the top mold surface 425 also define a resin channel 435 which is in fluid communication with a resin port 478. The resin port 478 attaches to resin line 479 which supplies resin pumped from a resin source 492 by pump assembly 490. Pump assembly 490 can comprise several pumps that are used to inject resin into the primary chamber 430 while also drawing a vacuum on the vacuum lines. Additionally, the rate of the resin pump can be adjusted control the rate at which resin is injected into the apparatus 400. Controlling the amount of resin injected into the porous material 432 can affect properties such as the flexibility, weight, and durability of the composite object. As illustrated in FIG. 5, the apparatus can include additional resin ports, such as second resin port 480 attached to second resin line 481 that supplies resin from the resin source 492 via pump assembly 490. Each resin port supplies resin to the resin channel 435. As illustrated in FIG. 4, the resin channel 435 is in fluid communication with the primary chamber 430 so that resin flows from the resin channel 435 into the primary chamber 430 where the resin is infused into the porous material 432.

Moving from the resin channel outward toward the perimeter of the apparatus 400, the inner bag surface 428 and the top mold surface 425 also define an outer vacuum channel 440 surrounded by an inner touchdown 450 and an outer touchdown 460. The arrangement of the outer vacuum channel 440, the inner touchdown 450, and the outer touchdown 460 secures the silicone bag 422 to the base mold 407 in an advantageous manner that is an improvement over the prior art. Specifically, the outer vacuum channel 440 eliminates the need for attachment mechanisms such as adhesives, clamps, or other components to secure the silicone bag 422 to the base mold 407. In prior art approaches, such attachment mechanisms can interfere with the manufacture of the composite object, can be prone to leaks, and can require frequent replacement. In contrast, using the outer vacuum channel 440, the inner touchdown 450, and the outer touchdown 460 to secure the silicone bag provides a clean and efficient mechanism while eliminating unnecessary components.

As illustrated in FIGS. 4 and 5, the outer vacuum channel 440 is in fluid communication with an outer vacuum port 482, which attaches to pump assembly 490 via outer vacuum line 483. In alternate embodiments, more than one outer vacuum port and outer vacuum line can be manufactured into the bag. The inner touchdown 450 is located between the resin channel 435 and the inner periphery 442 of the outer vacuum channel 440. The inner touchdown provides direct contact between an intermediate bag portion 452 of the inner bag surface 428 and an intermediate mold portion 451 of the top mold surface 425. When the vacuum is applied to the outer vacuum chamber 440, the inner touchdown provides a seal between the inner bag surface 420 and the top mold surface 425 so that resin in the resin channel 435 will only flow inward toward the primary chamber 430 and will not flow outward and leak from the apparatus 400.

Similarly, the outer touchdown 460 provides a seal along the outer periphery 444 of the outer vacuum channel so that a vacuum is maintained in the outer vacuum channel 440. The outer touchdown 460 provides direct contact between the inner bag surface 428 at the bag perimeter 462 and the mold perimeter 461 of the top mold surface 425.

In certain example embodiments, the outer vacuum channel 440 can include one or more protrusions 446 extending from the inner bag surface 428 into the outer vacuum channel 440. As described previously in connection with FIGS. 1-3, the protrusions are formed by recesses in the wax mold material placed at the outer perimeter of the base mold. The protrusions assist in maintaining a vacuum in the outer vacuum channel 440 by preventing the outer vacuum channel from collapsing completely when a vacuum is applied.

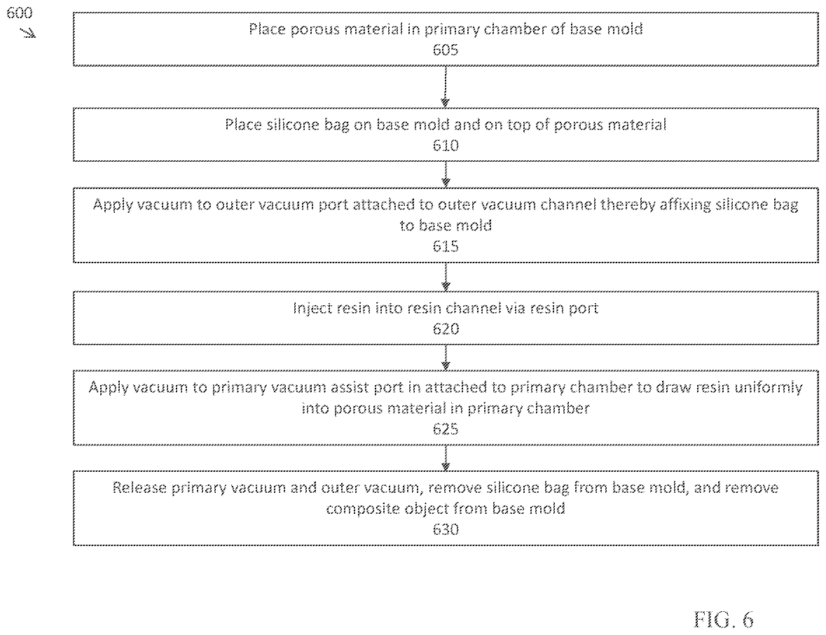

Referring now to FIG. 6, an example method 600 is described for forming a composite object using the apparatus illustrated in FIGS. 4 and 5. Beginning with step 605, the porous material 432 is placed within the primary chamber 430 of the apparatus 400. In step 610, the silicone bag 422 is placed on top of the porous material 432 and the top mold surface 425. In step 615, a vacuum is applied to the outer vacuum port 482 thereby creating a vacuum in the outer vacuum channel 440. The vacuum in the outer vacuum channel 440 creates a seal at the inner touchdown 450 and the outer touchdown 460 thereby securing the silicone bag 422 to the base mold 407. In step 620, resin is injected via the resin port 478 into the resin channel 435. The resin will begin to flow into the primary chamber 430 and be absorbed into the porous material 432. In step 625, a primary vacuum is applied at the primary vacuum assist port 472. The primary vacuum expedites the flow of resin and assists in drawing the resin into the porous material 432 in a uniform manner. Lastly, in step 630, the primary vacuum and the outer vacuum can be released. Once the resin has cured, the silicone bag 422 can be removed from the apparatus 400 and the composite object infused with the cured resin can be removed from the base mold 407.

The silicone bag and the base mold provide non-stick surfaces to which the resin does not adhere making the silicone bag and the base mold reusable so that the process 600 can be repeated multiple times to efficiently manufacture copies of the composite object while minimizing waste and delay. The method and apparatus of FIGS. 4-6 are an improvement over prior art techniques that require additional absorbing and sealing “peel” layers of material to draw and direct the resin into the porous material. Such absorbing and sealing peel layers are limited in the number of times they can be used because hardened resin adheres to and clogs the layers. The absorbing and sealing peel layers of the prior art are also more likely to malfunction in delivering resin consistently and uniformly to the porous material.

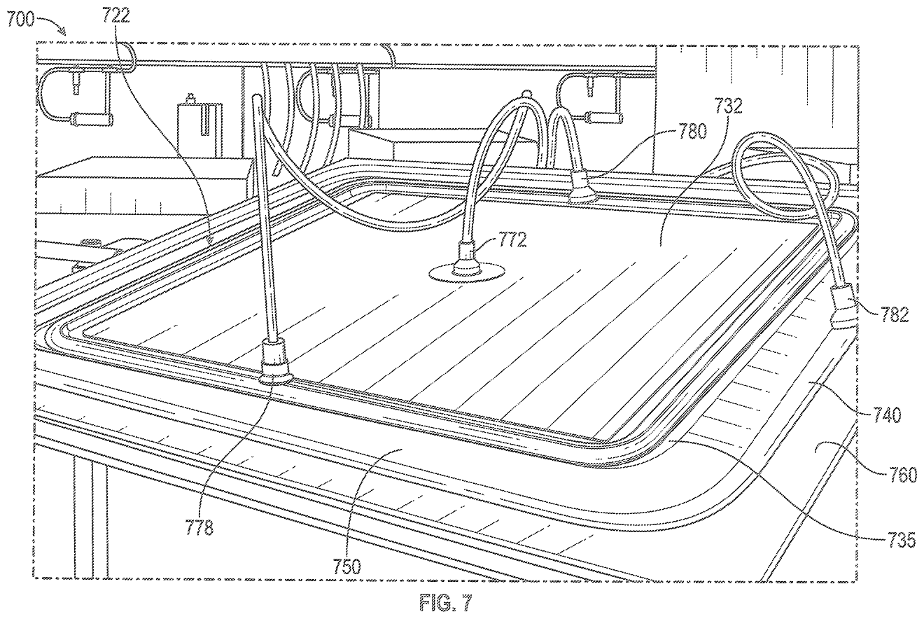

Referring to FIGS. 7, 8, and 9, another example embodiment of an apparatus for forming a composite object is illustrated. The apparatus 700 shown in FIGS. 7-9 is similar to apparatus 400 of FIGS. 4 and 5. Components in FIGS. 7-9 that are analogous to components in FIGS. 4 and 5 have same last two digits in the reference numbers shown in the Figures. Components in FIGS. 7-9 that have an analogous component in FIGS. 4 and 5 should be assumed to operate in a similar manner as the components described in connection with FIGS. 4 and 5.

Similar to apparatus 400, apparatus 700 comprises a silicone bag 722 secured to a base mold. A primary chamber defined between the base mold and the silicone bag 722 contains a porous material 732. Silicone bag 722 includes a primary vacuum assist port 722 located at or near the center of the silicone bag 722. The primary vacuum assist port 722 provides a vacuum force to the primary chamber that facilitates drawing resin from the perimeter of the apparatus into the porous material 732. Resin is supplied to the primary chamber and the porous material 732 by resin ports 778 and 780. Similar to apparatus 400, resin is pumped from a resin source through resin lines attached to the resin ports 778 and 780. Lastly, the outer portion of apparatus 700 comprises an outer vacuum channel 740 flanked by an inner touchdown 750 and an outer touchdown 760 in an arrangement similar to that in apparatus 400. A vacuum is applied to the outer vacuum channel 740 by an outer vacuum port 782 which is attached to a vacuum pump via vacuum line.

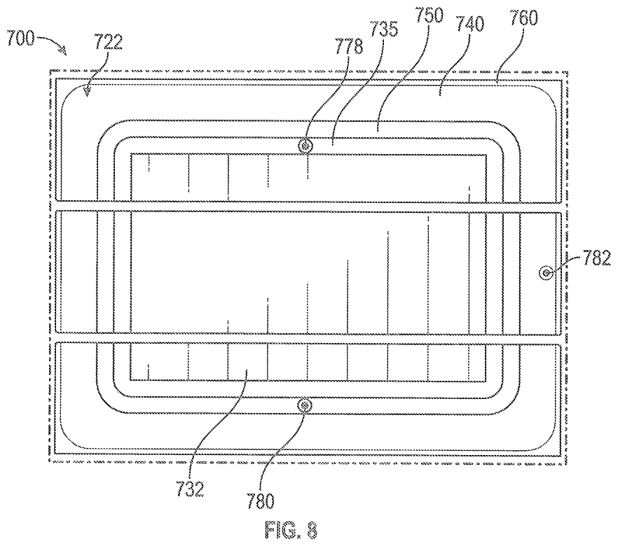

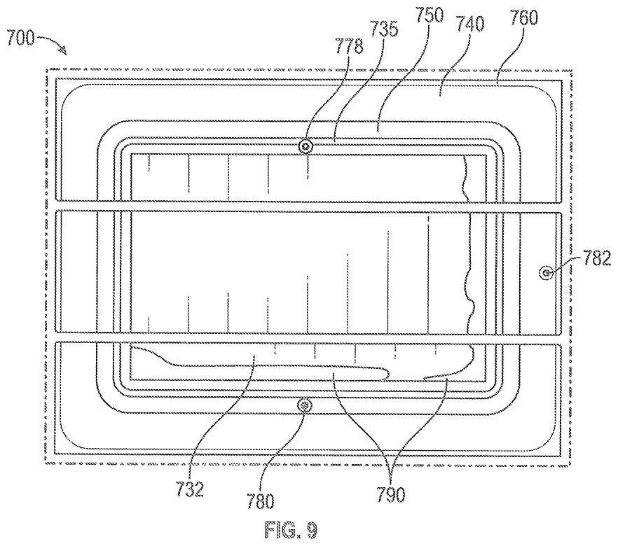

FIGS. 8 and 9 illustrate the apparatus 700, but on the opposite side to that shown in FIG. 7. In other words, FIGS. 8 and 9 show the underside of the apparatus 700 wherein the resin channel 735 and the porous material 732 are more visible. Also more visible is the outer vacuum channel 740 disposed between the inner touchdown 750 and the outer touchdown 760. In FIGS. 8 and 9, a pattern of channels and protrusions can be seen in the portion of the silicone bag 722 that defines the outer vacuum channel 740. The pattern of channels and protrusions assists in maintaining the vacuum channel in an open state when vacuum is applied from the outer vacuum port 782.

FIGS. 8 and 9 also assist in illustrating the flow of resin into the apparatus 700. In FIG. 8, the resin channel 735 is clear because resin has not yet begun to flow through the resin ports 778 and 780 into the resin channel 735. In contrast, in FIG. 9, resin has begun to flow from the resin ports 778 and 780 and the dark color of the resin can be seen flowing in the resin channel 735. Additionally, the darker regions 790 of the porous material 732 are regions where resin has permeated into the porous material 732.

Referring now to FIGS. 10 and 11, a finished composite object is illustrated. Specifically, referencing the apparatus 400 of FIGS. 4 and 5, the silicone bag 422 and its associated resin line and vacuum lines have been removed from the base mold 407. With the silicone bag 422 removed, the finished composite object 1094 is visible. The finished composite object 1094 consists of the porous material 432 which has been encased in cured resin. A raised rim 1092 around the perimeter of the composite object 1094 corresponds to the resin that was remaining in the resin channel and that cured along with the finished composite object 1094. The raised rim 1092 and other extraneous cured resin along the perimeter of the finished composite object 1094 can be trimmed to meet the final product specifications. In FIG. 11, the finished composite object 1094 has been lifted from the base mold 407 and turned over.

For any figure shown and described herein, one or more of the components may be omitted, added, repeated, and/or substituted. Accordingly, embodiments shown in a particular figure should not be considered limited to the specific arrangements of components shown in such figure. Further, if a component of a figure is described but not expressly shown or labeled in that figure, the label used for a corresponding component in another figure can be inferred to that component. Conversely, if a component in a figure is labeled but not described, the description for such component can be substantially the same as the description for the corresponding component in another figure.

With respect to the example methods described herein, it should be understood that in alternate embodiments, certain steps of the methods may be performed in a different order, may be performed in parallel, or may be omitted. Moreover, in alternate embodiments additional steps may be added to the example methods described herein. Accordingly, the example methods provided herein should be viewed as illustrative and not limiting of the disclosure.

Referring generally to the examples herein, any components of the apparatus (e.g., the mold, the ports, the vacuum and resin lines), described herein can be made from a single piece (e.g., as from a mold, injection mold, die cast, 3-D printing process, extrusion process, stamping process, or other prototype methods). In addition, or in the alternative, a component of the apparatus can be made from multiple pieces that are mechanically coupled to each other. In such a case, the multiple pieces can be mechanically coupled to each other using one or more of a number of coupling methods, including but not limited to epoxy, welding, fastening devices, compression fittings, mating threads, and slotted fittings. One or more pieces that are mechanically coupled to each other can be coupled to each other in one or more of a number of ways, including but not limited to couplings that are fixed, hinged, removeable, slidable, and threaded.

Terms such as “first”, “second”, “top”, “bottom”, “side”, “distal”, “proximal”, and “within” are used merely to distinguish one component (or part of a component or state of a component) from another. Such terms are not meant to denote a preference or a particular orientation, and are not meant to limit the embodiments described herein. In the example embodiments described herein, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

Although embodiments described herein are made with reference to example embodiments, it should be appreciated by those skilled in the art that various modifications are well within the scope of this disclosure. Those skilled in the art will appreciate that the example embodiments described herein are not limited to any specifically discussed application and that the embodiments described herein are illustrative and not restrictive. From the description of the example embodiments, equivalents of the elements shown therein will suggest themselves to those skilled in the art, and ways of constructing other embodiments using the present disclosure will suggest themselves to practitioners of the art. Therefore, the scope of the example embodiments is not limited herein.

1. An apparatus comprising:
a base mold having a top mold surface, the top mold surface comprising a mold perimeter, an intermediate mold portion, and a primary chamber, wherein the mold perimeter and the intermediate mold portion form a continuous horizontal surface;
a silicone bag secured to the top mold surface, an inner bag surface of the silicone bag and the top mold surface defining:
the primary chamber in fluid communication with a primary vacuum port, wherein the primary vacuum port is integrated into the silicone bag adjacent to the primary chamber;
a resin channel in fluid communication with a resin injection port and the primary chamber, wherein the resin injection port is integrated into the silicone bag adjacent to the resin channel;
an outer vacuum channel in fluid communication with an outer vacuum port, wherein the outer vacuum channel is formed on the continuous horizontal surface between the mold perimeter and the intermediate mold portion, and wherein the outer vacuum port is integrated into the silicone bag adjacent to the outer vacuum channel;
an inner touchdown disposed between the resin channel and an inner periphery of the outer vacuum channel; and
an outer touchdown portion disposed around an outer periphery of the outer vacuum channel.

2. The apparatus of claim 1, wherein the primary chamber is configured to contain a porous material.

3. The apparatus of claim 1, wherein at the outer touchdown a bag perimeter of the inner bag surface is in direct contact with the mold perimeter of the top mold surface.

4. The apparatus of claim 3, wherein at the inner touchdown an intermediate bag portion of the inner bag surface is in direct contact with the intermediate mold portion of the top mold surface.

5. The apparatus of claim 4, wherein a vacuum within the outer vacuum channel secures the silicone bag to the base mold at the outer touchdown and the inner touchdown.

6. The apparatus of claim 1, wherein the inner bag surface comprises at least one protrusion extending into the outer vacuum channel.

7. The apparatus of claim 1, wherein the resin injection port is configured to attach to a resin source.

8. The apparatus of claim 1, wherein the primary vacuum port is coupled to a primary pump and the outer vacuum port is coupled to a secondary pump.

9. The apparatus of claim 1, wherein the resin channel is located along a perimeter of the primary chamber, between the primary chamber and the inner touchdown.

10. A method of manufacturing a composite object, the method comprising:
placing a porous material on a top mold surface of a base mold, the top mold surface comprising a mold perimeter, an intermediate mold portion, and a primary chamber, wherein the mold perimeter and the intermediate mold portion form a continuous horizontal surface;
placing a silicone bag onto the porous material and the top mold surface, the silicone bag and the top mold surface defining:
the primary chamber in fluid communication with a primary vacuum port that is integrated into the silicone bag adjacent to the primary chamber, the primary chamber containing the porous material;
a resin channel in fluid communication with a resin injection port and the primary chamber, wherein the resin injection port is integrated into the silicone bag adjacent to the resin channel;
an outer vacuum channel in fluid communication with an outer vacuum port, wherein the outer vacuum channel is formed on the continuous horizontal surface between the mold perimeter and the intermediate mold portion, and wherein the outer vacuum port is integrated into the silicone bag adjacent to the outer vacuum channel;
an inner touchdown disposed between the resin channel and an inner periphery of the outer vacuum channel; and
an outer touchdown disposed around an outer periphery of the outer vacuum channel;
applying a primary vacuum to the primary vacuum port;
applying a secondary vacuum to the outer vacuum port; and
supplying resin to the resin injection port, the resin flowing through the resin channel to the primary chamber where the resin infuses the porous material.

11. The method of claim 10, further comprising:
allowing the resin to cure to form the composite object;
releasing the primary vacuum and the secondary vacuum;
removing the silicone bag from the top mold surface; and
removing the composite object from the base mold.

12. The method of claim 11, further comprising:
placing a second porous material within the primary chamber;
placing the silicone bag on the second porous material and the top mold surface;
applying the primary vacuum to the primary vacuum port;
applying the secondary vacuum to the outer vacuum port; and
supplying resin to the resin injection port, the resin flowing through the resin channel to the primary chamber where the resin infuses the second porous material.

13. The method of claim 10, wherein at the outer touchdown a bag perimeter of the inner bag surface is in direct contact with the mold perimeter of the top mold surface.

14. The method of claim 13, wherein at the inner touchdown an intermediate bag portion of the inner bag surface is in direct contact with the intermediate mold portion of the top mold surface.

15. The method of claim 14, wherein as a result of applying the secondary vacuum to the outer vacuum port, a vacuum in the outer vacuum channel secures the silicon bag to the base mold at the outer touchdown and the inner touchdown.

16. The method of claim 10, wherein the inner bag surface comprises at least one protrusion extending into the outer vacuum channel.

17. The method of claim 10, wherein the resin channel is located along a perimeter of the primary chamber, between the primary chamber and the inner touchdown.

18. (canceled)

19. (canceled)

20. (canceled)
